(19) United States
(12) Patent Application Publication
(10) Pub. No.: US 2014/0265338 A1
(43) Pub. Date: Sep. 18, 2014

(54) ASYMMETRIC FLOATS FOR WAVE ENERGY CONVERSION

(71) Applicants: JAMES G. BRETL, Doylestown, PA (US); JAMES EDER, Doytestown, PA (US)

(72) Inventors: JAMES G. BRETL, Doylestown, PA (US); JAMES EDER, Doytestown, PA (US)

(21) Appl. No.: 13/798,022

(22) Filed: Mar. 12, 2013

(51) Int. Cl. F03B 13/12

(52) U.S. Cl. CPC F03B 13/12
USPC 290/53

(57) ABSTRACT

A wave energy converter (WEC) includes a prismatic float having a quadrilateral-like cross section including a front plate, for facing incoming waves, a top plate, a bottom plate and a back plate. The front plate is connected at its top edge to the front end of the top plate which is disposed to be generally parallel to the surface of the water and at its bottom edge to the front end of the bottom plate. The plates are interconnected such that the sides of the top and front plates define an acute angle and the sides of the front and bottom plates define an obtuse angle. The back panel is connected between the back end of the top plate and the back end of the bottom plate. The exterior angle between the back panel and the top plate is generally less than 90 degrees. An extension plate may be added to the bottom plate which extends rearward of the float.

This application claims priority based on an application Ser. No. 61/685,125 filed Mar. 12, 2012 whose teaching and subject matter are incorporated herein by reference.

### BACKGROUND OF THE INVENTION

This invention relates to wave energy converters (WECs) for converting energy present in water waves into useful energy and, in particular, to floats, and their design, for use in wave energy converters (WECs) to provide improved power conversion efficiency. That is, this invention relates to apparatus for converting energy present in surface of bodies of water into useful energy and, in particular, to the design of floats (or shells) for use in wave energy converters.

Known WEC systems generally include a “float” (or “shell”) and a “spar” (or “shaft” or “column” or “piston”) which are designed to move relative to each other to convert the force of the waves into mechanical energy. In these systems, the float is generally depicted or referred to as the moving member and the spar as the non-moving or mechanically grounded member. But, the opposite may be the case. Alternatively, the spar and float may both move relative to each other.

Typically, the float and spar are formed so as to be axis-symmetric. A major advantage of axis-symmetric float shape is that mooring systems can be designed with little concern to the orientation of the float shape to the incident wave environment.

However, known axis-symmetric structures are not the most efficient structures when it comes to optimizing wave energy capture and power generation efficiency. This presents a significant and basic problem since a goal of all systems is to obtain the maximum power conversion efficiency.

Problems with axis-symmetry are also evident from the following considerations.

Point absorber theory predicts a limit on power absorption by a symmetric body in a wave field. That limit is commonly expressed as a ratio of the power absorbed to the power passing thru a plane that is orthogonal to and intercepts a length of the wave crest equal to the wave's length. Point absorber theory limits this ratio to about 1/6 for a vertically heaving body.

The body symmetry in the theory implies that waves will radiate in uniform rings as a result of the float's vertical motion. It is known in the art that it is theoretically possible to absorb more of the incident wave energy if the geometry of the body is sufficiently non-symmetric.

### SUMMARY OF THE INVENTION

Problems present in the prior art are overcome in systems embodying the invention by making the float to have an asymmetrical shape. In accordance with the invention, the float is made to have a non-symmetric float shape that exceeds the analytical point absorber performance for vertical oscillations. It does so by presenting an optimized wave reflecting surface to the direction from which waves are incident (upstream). Most of the incident wave energy is thus reflected and the transmitted waves are minimized. Further, the geometry of the body surface is such that radiated waves due to vertical oscillations are biased. Radiated waves are maximized in the upstream direction and minimized in the downstream direction.

Asymmetric floats-Applicants' invention is directed to asymmetrical float shapes which have been designed to have a geometry which will optimize energy capture from ocean waves for various sea states. This is based, in part, on the recognition that the directional performance of the shape is of interest. A study of the power performance as a function of the shape of the float relative to incident wave direction showed an improvement in the power generation efficiency and survivability of the WECs. This demonstrated that the use of asymmetric geometry achieved higher energy capture than is possible with a symmetric float shape.

In accordance with the invention there may be provided a mooring system that allows the float to rotate, allowing it to align itself with the direction of the wave climate. That is, it is possible to design a passive mooring arrangement to automatically align the system for optimal performance. It is also possible to design integral mechanical and control systems to orient the system.

A WEC embodying the invention may include two bodies, one of the two bodies referred to as the float lies along a plane generally parallel to the surface of the body of water and moves generally linearly (e.g., up and down) and the other body referred to as the spar remains relatively stationary or moves generally in a perpendicular direction to the body of water. Where the spar is moored, it may be moored to the seabed through either a fixed or compliant mooring system. A Power Take Off device (PTO) is coupled between the two bodies to convert their relative motion into useful energy (e.g., electric power). The PTO may be located inside or outside of the two bodies. The float geometry is optimized for wave energy conversion when undergoing linear oscillations between the spar and float.

A float embodying the invention include a first floating body having a quadrilateral-like cross section including: (a) a front panel having top and bottom edges, for facing incoming waves, (b) a top panel having front and back ends and intended to be disposed generally parallel to the still water surface, (c) a bottom panel having front and back ends, and (d) a back panel facing outgoing wave. The front panel is connected at its top edge to the front end of the top panel at a first acute angle and is connected at its bottom edge to the front end of the bottom panel at a second obtuse angle. The back panel is connected between the back end of the top panel and the bottom panel.

In one embodiment the back end of the bottom panel extends beyond the connection of the back panel to the bottom panel.

In general, the first floating body is formed with a central opening extending from the top panel of the first body through the first body and its bottom panel. The second which is a spar of shaft extends through the central opening of the first body.

The float shape is prismatic with the extruded direction oriented parallel to the wave crest with an extruded profile comprised of a polygonal shape.

Thus a float embodying the invention may include: (i) a 1^{st} (front) surface facing the incoming waves; (ii) an opposite 2^{nd} (back) surface facing the outgoing wave, (iii) a top 3^{rd} surface generally parallel to the water surface and connected between the top of the 1st and 2nd surfaces, (iv) a 4^{th} (bottom) surface opposite the 3^{rd} surface connected between the bottoms of the 1^{st} and 2^{rd} surfaces, (v) a 5^{th} (left side) surface. (vi) a 6^{th} (right side) surface and (vii) a 7^{th} surface extending away from the bottom of the second surface.

### BRIEF DESCRIPTION OF THE DRAWINGS

In the accompanying drawings, which are not drawn to scale, like reference characters denote like components, and

FIG. 1 is a drawing of a wave interference pattern with a float embodying the invention riding the surface of the waves;

FIG. 2 is an idealized, not to scale, drawing of a WEC comprising a float embodying the invention mounted on a spar in accordance with the invention;

FIG. 2A is a highly simplified block and cross-sectional diagram of a WEC embodying the invention;

FIG. 3 is a generalized cross sectional diagram of an asymmetric shaped float embodying the invention;

FIG. 3A is an isometric diagram of a prismatic shaped float embodying the invention;

FIG. 4 is a diagram indicating possible dimensions of a float embodying the invention;

FIG. 5 is a diagram of a linear array of WECs embodying the invention, arranged as an attenuator; and

FIG. 6 is a diagram of a two dimensional (2D) array of WECs embodying the invention.

### DETAILED DESCRIPTION OF THE INVENTION

FIG. 1 is a two-dimensional representation of a floating body 10 embodying the invention which may be used to form a wave energy converter (WEC). FIG. 1 shows the floating body 10 in the presence of an incident wave (travelling from left to right in FIG. 1) and illustrates that a good wave absorber must be a good wave maker. The waves caused by the body 10 are broken down into the two components, diffracted and radiated. The diffracted wave is a result of the incident wave and the presence of the body in the absence of any motion. The radiated wave is the result of the motion of the body in otherwise calm water.

Consider the floating body 10 to have a prismatic (depth) float shape that is extruded in a direction parallel to the wave crest. In the limiting case of a long prism, this becomes a 2-dimensional or long crested wave problem. As such, the disturbance waves can each be further broken down into two components. One set of disturbances propagates in the same direction (down-wave) as the incident wave (2 & 4), and the other disturbance propagates in the opposite (up-wave) direction (1 & 3). The optimal wave maker would generate up-stream disturbances that cancel each other completely, while the downstream components would cancel the incident completely. A useful parameterization of float geometry allows control of the amplitude as well as the phase relationship between the disturbance waves and the incident waves.

In accordance with the invention, it is possible to design the prismatic float to optimize the geometry of the prismatic float to favorably control the phase of the four disturbance waves in such a way that maximizes energy capture. The quadrilateral-like float 10 is shown in greater detail in FIGS. 3, 3A and 4. As illustrated in isometric FIG. 3A, a float 10 embodying the invention has a six (6) sided prismatic geometry.

FIG. 2 is a cross sectional diagram showing the float 10 mounted on a spar 12 which functions as a mooring arrangement. The float 10 has a central opening (shown as 26 in FIGS. 2A and 3A) into, or through which, the spar is fitted and the float 10 can move up and down relative to a spar 12 which, in FIG. 2, is shown secured to the sea bed. The mooring system of FIG. 2 constrains motion of the float 10 to vertical oscillations, for purpose of illustration. Therefore, the discussion herein is restricted to wave forces directed along the vertical. However, other mooring arrangements are possible and can be suitably accounted within the suggested geometry optimization.

FIG. 2A shows a power take off device (PTO) 25 coupled between the float 10 and the spar 12. The PTO 25 functions to convert the relative motion between the float 10 and spar 12 into useful energy (e.g., electric energy). The PTO 25 may be any known device. FIG. 2A also shows rotational control 27 to ensure that the float 10 and/or the spar 12 may be oriented or reoriented for best results. In FIG. 2A the spar is not fixedly connected to the sea bed, which allows for motion of the spar. Note that a heave plate (not shown) may be connected to the spar to add inertia to the spar.

The extruded cross section of the float 10 thus has 4 sides or facets. The invention allows for more than 4 facets for the purpose of manufacturability or performance enhancement.

Referring to the figures, note that a significant feature of asymmetrical floats embodying the invention is the shape and presence of the surfaces (identified by reference characters 5, 7, 9) facing the incoming waves. These surfaces provide a good wave reflecting surface and consequently they are good wave makers. These surfaces block the incident wave from passing and cause it to be reflected back from whence it came. Also, these surfaces radiate a wave as the float oscillates in response to the wave force and the PTO force. This geometry is such that the radiated wave is effective at canceling the reflected or diffracted wave.

Also, the back side of the float, or surface (6) and the top side of the lip (9) are facing the downstream direction. The direction that waves are propagating. These surfaces (6 and 9) are rather poor wave makers given vertical motions. Surface (6) is roughly vertical. Surface (9) is far from the free surface considering wave making. Given that much of the wave is diffracted by the front surfaces, the back surface should generate a smaller wave to cancel the smaller transmitted wave.

FIG. 3 shows a cross section of the float 10 and FIG. 3A is an isometric diagram of the cross-section of the float 10. FIGS. 3 and 3A show that the float includes a front surface (also referred to herein as a “panel” or “plate”) 5 intended to face the incoming waves. The front panel 5 has a top edge and a bottom edge. The top edge of front panel 5 is connected to the front end of a top panel 8. The top panel (or surface) 8 is nominally above the mean water level (see FIG. 4) and is nominally dry and is shown horizontal as it will be generally parallel to the surface of the water, when the water is still. The angle A between the top panel 8 and the front panel 5 is generally an acute angle. The bottom edge of the front panel 5 is connected to the front end of a bottom panel 7. The bottom panel 7 extends from panel 5 at an obtuse angle B. A back panel 6 which faces downstream is connected between the back or rear end of top panel 8 and the back end of panel 7. The exterior angle C between the back panel and the horizontal plane will generally be acute but may even be a 90 degree angle. A plate (9) is shown that appears to be an extension of surface (7). It is parallel to surface (7) and it extends past the down-wave facing surface (6). The plate (or lip) 9 may be retractable. Thus, plate 9 may be part of plate 7 or it may be a separate plate mounted along plate 7 and may be selectively retracted or extended. As noted above there is a centrally located opening 26 which extends from the top plate 8 through the bottom plate 7 for enabling as par or shaft to pass through the float.

The cross section of float 10 can be fully defined by specifying six parameters. Six such parameters could include the length of the back and top plates (6 & 8), the angles (A, B & C) and the length of the plate (9). In one embodiment shown in FIG. 4, a float 10 embodying the invention was designed with the following parameters: top plate 8 was made 11.8 meters long, plate 5 was made 4.53 meters long and the angle A between plates 5 and 8 was 57.4 degrees. Bottom plate 7 was made 11 meters long. Plate 9 extended 2 meters from the junction of plates 6 and 7. This was done for a prismatic float having depth of 15 meters.

Hydrodynamic wave excitation can be considered complex. That is, the force can be separated into two components, a real and an imaginary. The real component is associated with acceleration and position and the other component then is imaginary, and is in phase with velocities. Further, given linear wave theory, it is possible to estimate the character of hydrodynamic loads on a given surface by considering the orientation of the surface normal directed into the fluid.

Assume that a surface having a downward pointing normal experiences excitation in phase with the fluid accelerations and that the fluid velocity lags acceleration. Thus, the free surface elevation for a monochromatic wave could be described by the equation TJ=a cos(kx−wt) for a wave propagating in the x direction. It follows that the phase of the excitation force experienced by the plate will shift as the surface normal rotates in the vertical plane parallel to the propagation direction. Counterclockwise rotation of the normal causes a proportional phase lag in the excitation force. Clockwise rotation causes a proportional phase lead.

With this in mind, the three wetted sides (5,6 &7) of the float 10 have influence on the phase and magnitude of the diffraction and radiation forces experienced by the float. The following observations are used to guide design.
The length of (8) and the angles (A & C) determine the nominal water plane surface area. This corresponds to a stiffness (real) term in both the diffraction and radiation wave force problems.
The magnitudes of the excitation forces associated with surfaces (5, 6, 7 & 9) depend on their wetted length.
The angles (A, B & C) decrease the vertical projection of the excitation force on panels (5, 6, 7 & 9). This means that as these angles increase, the vertical excitation on the float decreases.
The angles (A & B) proportionally increase the phase of the excitation force on (5, 7 & 9). This means that the both the hydrodynamic excitation force, increasingly lags the excitation associated with the water plane.
The acute angle (C) proportionally decreases the phase of the excitation force on (6) relative to the incident wave.
The radiated waves will follow the same phase relationships for periodic vertical oscillations of the float.
The overall length of (5, 7 & 9) can be considered a characteristic length scale, lambda, for the float geometry. This length can be used to determine the range of wave lengths (or frequency by dispersion) that the geometry can dynamically interact with. The shape will exhibit higher efficiencies for wave lengths in the range of 2 lambda to 5 lambda. As noted earlier, the portion (9) of surface (7) extending past (6) can be retracted. This provides a means to tune the float to ambient wave conditions and also provides a means to shed loads in energetic wave conditions.
The sides (5 & 7) are strongly associated with the disturbance waves (1 & 3) traveling up-wave.
The side (6) and the top surface of plate (9) are strongly associated with the disturbance waves (2 & 4) that propagate down-wave.

The phase and magnitude of the diffracted and radiated waves can be determined. Power conversion can then be estimated using an appropriate power take off model. Using the above methodology and taking into account the expected wave climate for a specific site leads to a shape that is similar to the notional geometry suggested herein.

Based upon the foregoing, the dimensions of a float for specific site and wave condition can be determined as shown, for example, in FIG. 4. It is anticipated that the principles taught herein can be used to obtain other dimensions which achieve substantially the same purpose.

The application of point absorber theory indicates that power absorption has a theoretical limit equivalent to the energy transport in a monochromatic wave having a crest length of 1/rr(wavelength) for oscillation in a single degree of freedom. The asymmetry admitted in this design precludes consideration of point absorber theory.

In accordance with the invention, a linear array of WECs embodying the invention could be arranged as shown in FIG. 5. In the limit of close spacing, the WEC array can be considered an attenuator.

The WECs embodying the invention can also be arranged as shown in FIG. 6 to form a two dimensional (2D) array of wave energy converters.

What is claimed is:

1. A wave energy converter (WEC) intended to be place in a body of water subjected to wave motion of varying amplitude and frequency, said WEC comprising:
first and second bodies; said first body being a floating body tending to move generally in phase with the waves and differentially relative to the second body;
said first body having a quadrilateral-like cross section including: (a) a front panel having top and bottom edges, for facing incoming waves, (b) a top panel having front and back ends and intended to be disposed generally parallel to the still water surface, (c) a bottom panel having front and back ends, and (d) a back panel; and
wherein the front panel is connected at its top edge to the front end of the top panel at a first acute angle and is connected at its bottom edge to the front end of the bottom panel at a second obtuse angle; and wherein the back panel is connected between the back end of the top panel and the bottom panel.

2. A wave energy converter (WEC) as claimed in claim 1, wherein the back end of the bottom panel extends beyond the connection of the back panel to the bottom panel.

3. A wave energy converter (WEC) as claimed in claim 1, wherein an additional extension panel is attached to the bottom panel, in parallel therewith and extending rearward.

4. A wave energy converter (WEC) as claimed in claim 1, wherein there is a central opening extending from the top panel of said first body through said first body and its bottom panel; and wherein said second body is a spar which extends through the central opening of the first body.

5. A wave energy converter (WEC) as claimed in claim 4, wherein said first body moves substantially in a vertical direction along the spar.

6. A wave energy converter (WEC) as claimed in claim 4, wherein a power take off device (PTO) is coupled between the first and second bodies to convert their relative motion to electric energy.

7. A wave energy converter (WEC) as claimed in claim 1, wherein said the float shape is prismatic with the extrude direction being oriented parallel to the wave crest.

8. A wave energy converter (WEC) as claimed in claim 3, wherein the extension panel extends in the wave propagation direction beyond the adjacent back panel.

9. A wave energy converter (WEC) as claimed in claim 3, wherein the extension panel is retractable or extendable.

10. A wave energy converter (WEC) as claimed in claim 1 further including means for enabling the float to rotate about the vertical axis so as to maintain its front panel facing the incoming waves.

11. An array of wave energy converters (WECs), each one of said WECs including first and second bodies; said first body being a floating body tending to move generally in phase with the waves and differentially relative to the second body; said first body having a quadrilateral-like cross section including: (a) a front plate having top and bottom edges, for facing incoming waves, (b) a top plate having front and back ends and intended to be disposed generally parallel to the still water surface, (c) a bottom plate having front and back ends, and (d) a back plate; and
wherein the front plate is connected at its top edge to the front end of the top plate at a first acute angle and is connected at its bottom edge to the front end of the bottom plate at a second obtuse angle; and wherein the back plate is connected between the back end of the top plate and the bottom plate.

12. An array of wave energy converters as claimed in claim 11 for forming a two dimensional array.
